(19) United States
(12) Patent Application Publication
(10) Pub. No.: US 2019/0291211 A1
(43) Pub. Date: Sep. 26, 2019

(54) NOZZLE AND ADDITIVE MANUFACTURING APPARATUS

(71) Applicants: Technology Research Association for Future Additive Manufacturing, Chuo-ku (JP); KABUSHIKI KAISHA TOSHIBA, Minato-ku (JP); Toshiba Kikai Kabushiki Kaisha, Chiyoda-ku (JP)

(72) Inventors: Satoshi TSUNO, Ota (JP); Hiroshi Ohno, Chuo (JP); Mitsuo Sasaki, Chigasaki (JP); Tomohiko Yamada, Yokohama (JP); Yasutomo Shiomi, Koza (JP); Shimpei Fujimaki, Mishima (JP)

(73) Assignees: Technology Research Association for Future Additive Manufacturing, Chuo-ku (JP); KABUSHIKI KAISHA TOSHIBA, Minato-ku (JP); Toshiba Kikai Kabushiki Kaisha, Chiyoda-ku (JP)

(21) Appl. No.: 16/359,384

(22) Filed: Mar. 20, 2019

(30) Foreign Application Priority Data
Mar. 26, 2018 (JP) 2018-058715

(51) Int. Cl. B23K 26/342; B33Y 30/00; B23K 26/144; B23K 26/14

(52) U.S. Cl. CPC B23K 26/342; B23K 26/1488; B23K 26/144; B33Y 30/00

(57) ABSTRACT

According to an embodiment, a nozzle of an additive manufacturing device includes a first inner surface that defines a first path through which an energy ray passes; and a second inner surface that defines a second path that extends along the first path and through which gas and a powder material pass. The first path opens to a leading end of the nozzle. The second path opens to near or around the first path. At least part of the second inner surface includes a first region having a larger friction coefficient for the powder material than the friction coefficient of at least one of the first inner surface and an outer peripheral surface of the leading end.

### CROSS-REFERENCE TO RELATED APPLICATIONS

This application is based upon and claims the benefit of priority from Japanese Patent Application No. 2018-058715, filed Mar. 26, 2018, the entire contents of which are incorporated herein by reference.

### FIELD

Embodiments described herein relate generally to a nozzle and an additive manufacturing apparatus.

### BACKGROUND

Conventionally, additive manufacturing apparatuses that additively manufacture objects are known. Such an additive manufacturing apparatus supplies a powder material through a nozzle and irradiates and melts the powder with a laser beam from the nozzle to manufacture objects by forming and adding layers of the material(described in Japanese Patent Application Laid-open No. 2009-001900, for example).

It is useful to provide an additive manufacturing apparatus that can enhance the convergence of powder material to be supplied to an intended location or position, for example.

### BRIEF DESCRIPTION OF THE DRAWINGS

FIG. 1 is an exemplary schematic diagram illustrating the configuration of an additive manufacturing apparatus according to an embodiment;

FIG. 2 is an exemplary schematic explanatory diagram illustrating an exemplary additive manufacturing procedure (manufacturing method) performed by the additive manufacturing apparatus according to the embodiment;

FIG. 3 is an exemplary schematic sectional view of a leading end of a nozzle according to the embodiment;

FIG. 4 is an exemplary schematic cross-sectional view of the nozzle according to the embodiment taken along line IV-IV in FIG. 3;

FIG. 5 is an exemplary schematic diagram of a measurement device for the friction coefficient of each surface of the nozzle with respect to powder according to the embodiment;

FIG. 6 is an exemplary schematic graph of the friction coefficient of each surface of the nozzle with respect to powder according to the embodiment, showing the correlation between a tensile force and a vertical load; and

FIG. 7 is an exemplary schematic graph of the friction coefficient of each surface of the nozzle with respect to powder according to the embodiment, showing the correlation between the particle size of powder material and the friction coefficient.

### DETAILED DESCRIPTION

In general, according to one embodiment, a nozzle of an additive manufacturing device includes a first inner surface and a second inner surface. The first inner surface defines a first path through which an energy ray passes. The second inner surface defines a second path that extends along the first path and through which gas and a powder material pass. The first path opens to a leading end of the nozzle, and the second path opens to near or around the first path. At least part of the second inner surface includes a first region having a larger friction coefficient for the powder material than a friction coefficient of at least one of the first inner surface and an outer peripheral surface of the leading end.

Hereinafter, exemplary embodiments and modifications of the present invention will be disclosed below. The configurations and controls (technical features) of the exemplary embodiments and modifications to be described below, and operations and results (effects) provided by the configurations and controls are merely exemplary.

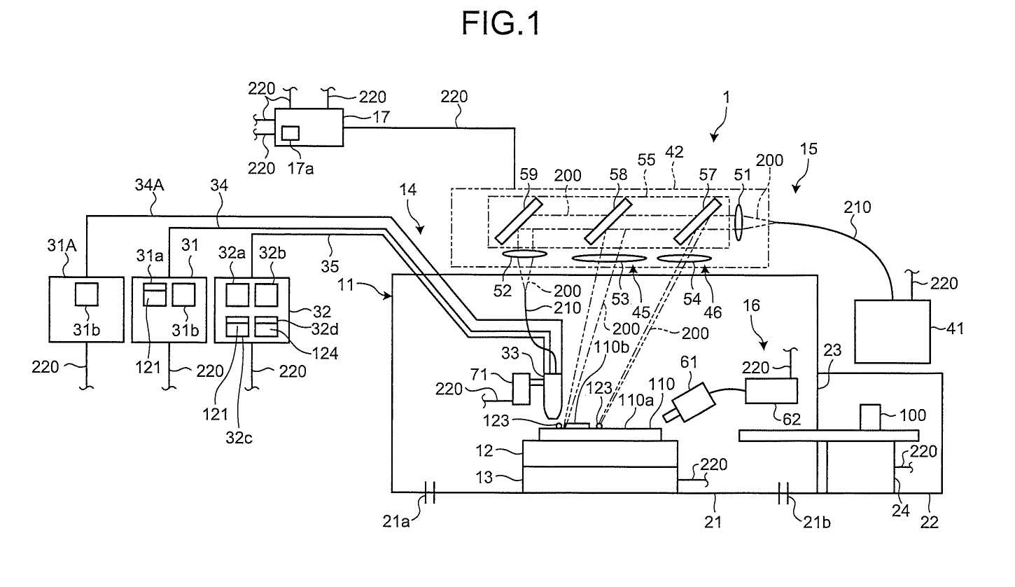

As illustrated in FIG. 1, an additive manufacturing apparatus 1 includes a processing tank 11, a stage 12, a mover device 13, a nozzle device 14, an optical device 15, a measurement device 16, and a control device 17.

The additive manufacturing device 1 supplies a material 121 from the nozzle device 14 to additively manufactures an object 100 in a certain shape from the material by adding, onto an object 110 placed on the stage 12, a layer upon a layer of the material 121.

The object 110 is an intended object to be supplied with the material 121 from the nozzle device 14, and includes a base 110a and a layer 110b. A plurality of layers 110b is added on the top face of the base 110a. The material 121 represents, for example, a metal or resin powder material. One or more materials 121 may be used in the additive manufacturing.

The processing tank 11 includes a main chamber 21 and an auxiliary chamber 22. The auxiliary chamber 22 is adjacent to the main chamber 21. A door 23 is provided between the main chamber 21 and the auxiliary chamber 22. While the door 23 is opened, the main chamber 21 and the auxiliary chamber 22 are communicated with each other. When the door 23 is closed, the main chamber 21 is placed in an airtight state.

The main chamber 21 is provided with an inlet 21aand an outlet 21b. A gas supply device (not illustrated) operates and supplies inert gas such as nitrogen or argon into the main chamber 21 through the inlet 21a. An exhaust device (not illustrated) operates and discharges gas from the main chamber 21 through the outlet 21b.

A transfer device (not illustrated) is provided in the main chamber 21. A conveyer device 24 is placed in the main chamber 21 and the auxiliary chamber 22. The transfer device passes the object 100 from the main chamber 21 to the conveyer device 24 after processing. The conveyer device 24 receives the object 100 from the transfer device and conveys it into the auxiliary chamber 22. That is, the auxiliary chamber 22 houses the object 100 having been processed in the main chamber 21. After the object 100 is housed in the auxiliary chamber 22, the door 23 is closed to isolate the auxiliary chamber 22 from the main chamber 21.

The main chamber 21 contains the stage 12, the mover device 13, part of the nozzle device 14, and the measurement device 16.

The stage 12 supports the object 110. The mover device 13 (moving mechanism) is capable of moving the stage 12 in three axial directions orthogonal to one another.

The nozzle device 14 supplies the material 121 to the object 110 placed on the stage 12. The nozzle device 14 includes a nozzle 33 that emits a laser beam 200 onto the object 110 on the stage 12. The nozzle device 14 may supply a plurality of materials 121 in parallel or selectively supply one of the materials 121. The nozzle 33 emits the laser beam 200 in parallel with the supply of the material 121. The laser beam 200 is an exemplary energy ray. Any energy ray other than a laser beam may be used. The energy ray needs to be able to melt the material such as a laser beam and may be an electron beam or electromagnetic wave in microwave to ultraviolet range.

The nozzle device 14 includes a supply device 31, a supply device 31A, an exhaust device 32, the nozzle 33, and a supply tube 34. The material 121 is supplied from the supply device 31 to the nozzle 33 through the supply tube 34. Gas is supplied from the supply device 31A to the nozzle 33 through a supply tube 34A. The material 121 is transferred from the nozzle 33 to the exhaust device 32 through an exhaust tube 35.

The supply device 31 includes a tank 31a and a supply unit 31b. The tank 31a houses the material 121. The supply unit 31b supplies a certain amount of the material 121 from the tank 31a. The supply device 31 supplies carrier gas (gaseous matter) containing the powder material 121. The carrier gas is, for example, inert gas such as nitrogen or argon. The supply device 31A includes the supply unit 31b. The supply device 31A supplies gas (gaseous matter) of the same kind as that supplied by the supply device 31.

The exhaust device 32 includes a classifier device 32a, an exhaust unit 32b, and tanks 32c and 32d. The exhaust unit 32b suctions gas from the nozzle 33. The classifier device 32a separates the material 121 from fumes. The tank 32c houses the material 121, and the tank 32d houses fumes 124. Thereby, the powder material 121 unused in the manufacturing, and fumes (metal fumes) generated from the manufacturing, and refuse, for example, are discharged together with gas from a processing area. The exhaust unit 32b represents, for example, a pump.

As illustrated in FIG. 1, the optical device 15 includes a light source 41 and an optical system 42. The light source 41 includes an oscillation element (not illustrated), and emits the laser beam 200 by oscillation of the oscillation element. The light source 41 can change the power intensity of the laser beam to emit.

The light source 41 is connected with the optical system 42 through a cable 210. The laser beam 200 is emitted from the light source 41 and enters the nozzle 33 through the optical system 42. The nozzle 33 sprays the material 121 toward the object 110 and emits the laser beam 200 to the object 110 and the material 121.

Specifically, the optical system 42 includes a first lens 51, a second lens 52, a third lens 53, a fourth lens 54, and a Galvano scanner 55. The first lens 51, the second lens 52, the third lens 53, and the fourth lens 54 are fixed. The optical system 42 may include a regulator that can move the first lens 51, the second lens 52, the third lens 53, and the fourth lens 54 in two axial directions, specifically, directions intersecting the optical path (for example, orthogonal directions).

The first lens 51 converts the laser beam 200 incident through the cable 210 into parallel light. The converted laser beam 200 is incident on the Galvano scanner 55.

The second lens 52 converges the laser beam 200 emitted from the Galvano scanner 55. Converged by the second lens 52, the laser beam 200 reaches the nozzle 33 through the cable 210.

The third lens 53 converges the laser beam 200 emitted from the Galvano scanner 55. Converged by the third lens 53, the laser beam 200 and is emitted to the object 110.

The fourth lens 54 converges the laser beam 200 emitted from the Galvano scanner 55. Converged by the fourth lens 54, the laser beam 200 is incident on the object 110.

The Galvano scanner 55 splits the parallel light converted through the first lens 51 into light beams to be incident on the second lens 52, the third lens 53, and the fourth lens 54. The Galvano scanner 55 includes a first Galvano mirror 57, a second Galvano mirror 58, and a third Galvano mirror 59. Each of the Galvano mirrors 57, 58, and 59 can split light and change a tilt angle (output angle) thereof.

The first Galvano mirror 57 transmits part of the laser beam 200 having passed through the first lens 51 to the second Galvano mirror 58. The first Galvano mirror 57 reflects the rest of the laser beam 200 to the fourth lens 54. The first Galvano mirror 57 changes the tilt angle thereof to change the output position of the laser beam 200 having passed through the fourth lens 54.

The second Galvano mirror 58 transmits part of the laser beam 200 having passed through the first Galvano mirror 57 to the third Galvano mirror 59. The second Galvano mirror 58 reflects the rest of the laser beam 200 to the third lens 53. The second Galvano mirror 58 changes the tilt angle thereof to change the output position of the laser beam 200 having passed through the third lens 53.

The third Galvano mirror 59 emits, to the second lens 52, part of the laser beam 200 having passed through the second Galvano mirror 58.

In the optical system 42, a melting device 45 comprises the first Galvano mirror 57, the second Galvano mirror 58, and the third lens 53. The melting device 45 irradiates the material 121 (123), supplied from the nozzle 33, on the object 110 with the laser beam 200 for heating the material, to thereby form the layer 110b and performs annealing.

The optical system 42 includes a remover device 46 for the material 121. The remover device 46 irradiates an unnecessary material on the base 110a or the layer 110b with the laser beam 200 for removal. Specifically, the remover device 46 removes a material of the object 100 deviating from a certain shape, such as an unnecessary scattered material occurring from the material 121 supplied from the nozzle 33, or an unnecessary material occurring from the formation of the layer 110b. The remover device 46 emits the laser beam 200 with a power intensity sufficient for removing such unnecessary materials.

The measurement device 16 measures the shape of the solidified layer 110b and the shape of the manufactured object 100. The measurement device 16 transmits information on the measured shapes to the control device 17. The measurement device 16 includes, for example, a camera 61 and an image processing device 62. The image processing device 62 performs image processing on information generated by the camera 61. The measurement device 16 measures the shape of the layer 110b and the shape of the manufactured object 100 by, for example, interferometry or light-sectioning.

A mover device 71 (moving mechanism) can move the nozzle 33 in three axial directions orthogonal to one another.

The control device 17 is electrically connected to the mover device 13, the conveyer device 24, the supply device 31, the supply device 31A, the exhaust device 32, the light source 41, the Galvano scanner 55, the image processing device 62, and the mover device 71 through a signal line 220.

The control device 17 controls the mover device 13 to move the stage 12 in the three axial directions. The control device 17 controls the conveyer device 24 to convey the manufactured object 100 to the auxiliary chamber 22. The control device 17 controls the supply device 31 to control supply or non-supply of the material 121 and adjust the supply amount thereof. The control device 17 controls the exhaust device 32 to detect presence or absence of the powder material 121 and fumes to exhaust and adjust the amount of exhaust. The control device 17 controls the light source 41 to adjust the power intensity of the laser beam 200 to emit. The control device 17 controls the Galvano scanner 55 to adjust the tilt angle of each of the first Galvano mirror 57, the second Galvano mirror 58, and the third Galvano mirror 59. The control device 17 controls the mover device 71 to control the position of the nozzle 33.

The control device 17 includes a storage 17a. The storage 17a stores, for example, data indicating a shape (reference shape) of the object 100 to be manufactured. The storage 17a also stores, for example, data indicating the height of the nozzle 33 and the height of the stage 12 in each three-dimensional processing position (each point).

The control device 17 may include the function of selectively supplying different materials 121 through the nozzle 33 and adjusting or changing the ratio of the materials 121. For example, the control device 17 controls the supply device 31 on the basis of data indicating the ratio of the materials 121 and stored in the storage 17a, to form the layer 110b of the materials 121 at the ratio. Owing to the function, the additive manufacturing device 1 can manufacture a gradient material (gradient function material) with a varying (gradually decreasing or increasing) ratio of the materials 121 depending on a position or location on the object 100. Specifically, to form the layer 110b, for example, the control device 17 can control the supply device 31 to supply the materials 121 at a set or stored ratio to each of the three-dimensional coordinates of the object 100 to manufacture the object 100 being a gradient material (gradient function material) with a varying ratio of the materials 121 in any of three-dimensional directions. The change amount (change rate) of the ratio of the materials 121 per unit length may be set in various manners.

The control device 17 includes the function of determining the shape of the material 121. For example, the control device 17 determines whether the layer 110b or the manufactured object 100 includes a part deviating from the certain shape by comparing the shape of the layer 110b or the object 100, measured by the measurement device 16, with the reference shape stored in the storage 17a.

The control device 17 also includes the function of trimming the material 121 into the certain shape by removing an unnecessary material, determined to deviate from the certain shape, from the material 121. For example, when the material 121 scatters and attaches to a location deviating from the certain shape, the control device 17 first controls the light source 41 to emit the laser beam 200 to the material 121 through the first Galvano mirror 57 and the fourth lens 54 with power intensity sufficient to evaporate the unnecessary material. Then, the control device 17 controls the first Galvano mirror 57 to irradiate the unnecessary material with the laser beam 200 and evaporate the material.

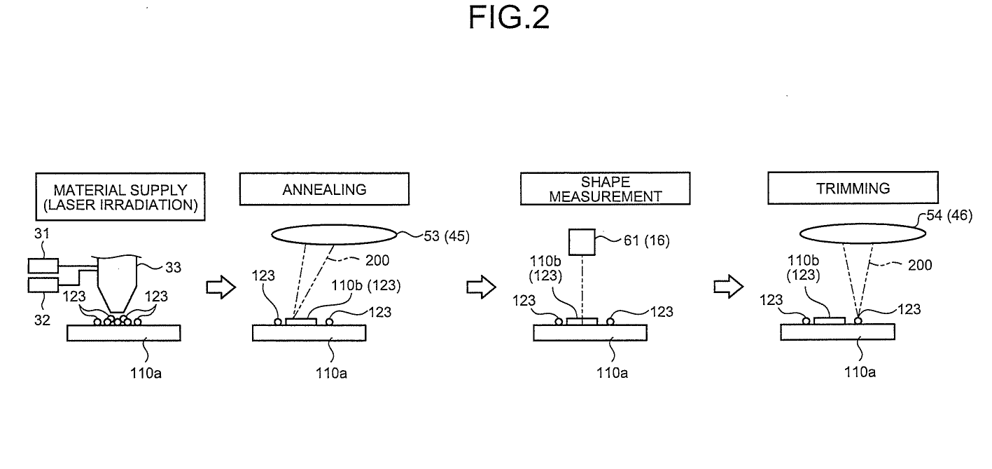

The following describes a manufacturing method of the object 100 by the additive manufacturing apparatus 1 with reference to FIG. 2. As illustrated in FIG. 2, the additive manufacturing apparatus 1 first supplies the material 121 and irradiates the material 121 with the laser beam 200. The control device 17 controls the supply devices 31 and 31A to supply the material 121 from the nozzle 33 to a certain area, and also controls the light source 41 and the Galvano scanner 55 to melt the supplied material 121 with the laser beam 200. Thereby, as illustrated in FIG. 2, a certain amount of a melted material 123 is supplied to an area, on the base 110a, to become the layer 110b. The material 123 is sprayed onto the base 110a or the layer 110b and deformed into an aggregate of layers of or thin films of the material 123, for example. Alternatively, the material 123 is cooled by gas (gaseous matter) carrying the material 121 or through heat transfer to the aggregate of the material 121, and granularly layered into a granular aggregate.

Subsequently, the additive manufacturing apparatus 1 performs annealing. The control device 17 controls the light source 41 and the melting device 45 to emit the laser beam 200 to the aggregate of the material 123 on the base 110a. This re-melts the aggregate of the material 123 into the layer 110b.

Subsequently, the additive manufacturing apparatus 1 performs shape measurement. The control device 17 controls the measurement device 16 to measure the material 123 on the base 110a after the annealing. The control device 17 compares the shape of the layer 110b or the manufactured object 100 measured by the measurement device 16 with the reference shape stored in the storage 17a.

Subsequently, the additive manufacturing apparatus 1 performs trimming. When determining through the shape measurement and the comparison with the reference shape that the material 123 attaches to a position on the base 110a deviating from the certain shape, for example, the control device 17 controls the light source 41 and the remover device 46 to evaporate the unnecessary material 123. When determining through the shape measurement and the comparison with the reference shape that the layer 110b has the certain shape, the control device 17 refrains from trimming.

After the formation of the layer 110b, the additive manufacturing apparatus 1 forms a new layer 110b on the layer 110b. The additive manufacturing apparatus 1 repetitively adds layers 110b to manufacture the object 100.

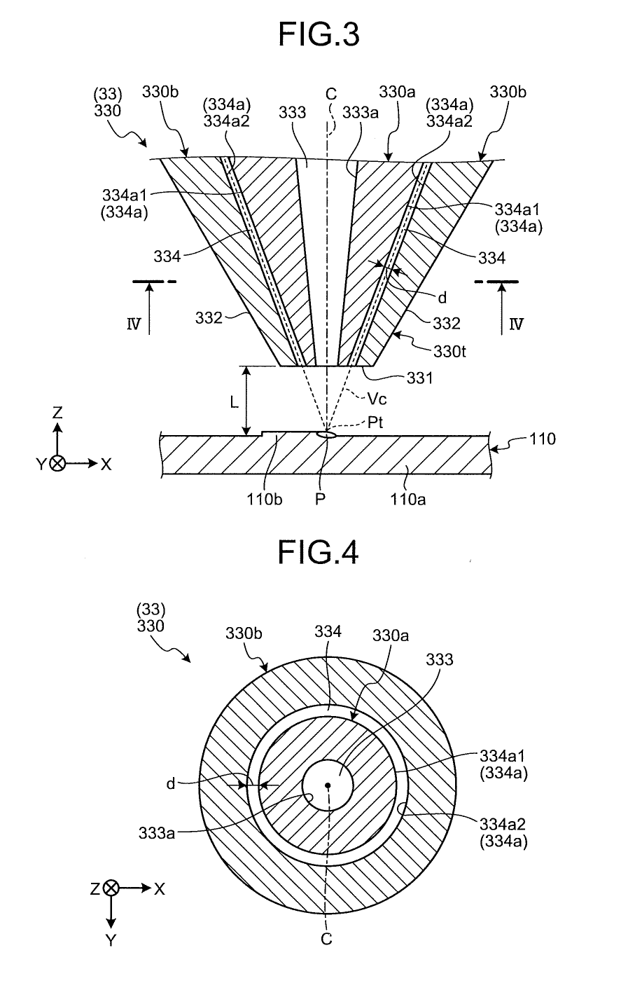

The following describes exemplary detailed configuration and function of the nozzle 33 according to the present embodiment with reference to FIGS. 3 and 4. In the following description, an X direction, a Y direction, and a Z direction orthogonal to one another are defined for the purpose of illustration. The X direction corresponds to horizontal direction in FIG. 3, the Y direction corresponds to the direction perpendicular to FIG. 3, and the Z direction corresponds to vertical direction in FIG. 3. The X direction, the Y direction, and the Z direction are orthogonal to one another.

As illustrated in FIG. 3, the stage 12, the object 100, the object 110, the base 110a, and the top surface of the layer 110b expand substantially along a plane in the X direction and the Y direction. In the additive manufacturing apparatus 1, at least one of the nozzle 33 and the stage 12 moves in the X direction and the Y direction for their relative movement to form the layer 110b of the material 121 along the plane in the X direction and the Y direction. Then, layers 110b of the material 121 are successively added in the Z direction to form the three-dimensional object 100. The X direction and the Y direction may be referred to as, for example, a horizontal direction or a lateral direction. The Z direction may be referred to as, for example, a perpendicular direction, a vertical direction, a height direction, a thickness direction, or a longitudinal direction. The X direction and the Y direction may be also referred to as a scanning direction, and the Z direction may be also referred to as a layered direction or an output direction of the laser beam 200.

The nozzle 33 includes a body 330. The body 330 has an elongated shape in its entirety, and contains a heat-resistive material, such as boron nitride (ceramic material). The longitudinal direction (axial direction) of the body 330 corresponds to the Z direction, for example. The transverse direction (width direction) of the body 330 corresponds to the X direction or the Y direction, for example. The body 330 has a substantially cylindrical shape. However, the body 330 has a tapered leading end 330t.

The leading end 330t of the body 330 illustrated in FIG. 3 has an outer surface including an end face 331 and an outer peripheral surface 332. The end face 331 is located at the longitudinal end (bottom end) of the body 330, and may be also referred to as a bottom surface. The end face 331 faces, for example, the stage 12, the object 100, the object 110, and a melting pool P. The end face 331 has a flat shape in the X direction and the Y direction.

The outer peripheral surface 332 is located at the transverse end of the body 330. The outer peripheral surface 332 has a diameter that decreases as it approaches the end face 331. The outer peripheral surface 332 has a conical shape. The outer peripheral surface 332 may be also referred to as a side surface. The outer peripheral surface 332 of the leading end 330t is, for example, an annular region near the leading end (for example, the end face 331) of the body 330 (nozzle 33), specifically a mirror-finished region.

The body 330 is provided with an opening 333. The opening 333 extends in the longitudinal direction of the body 330 along a central line C (axis) of the body 330. The opening 333 penetrates through the body 330 in the Z direction. The opening 333 may be also referred to as a first through-hole. The opening 333 opens to the end face 331 of the body 330.

The opening 333 serves as the path of the laser beam 200. The laser beam 200 is emitted toward the melting pool P through the opening 333 in the end face 331. The Z direction corresponds to the longitudinal direction of the body 330 and the opening 333, the direction in which the opening 333 extends, and the output direction of the laser beam 200.

The opening 333 has a circular cross section in the transverse direction intersecting the Z direction. The circular section of the opening 333 has a diameter which decreases as it approaches the end face 331. Thus, an inner surface 333a of the opening 333, in other words, the inner surface 333a defining the opening 333 is a conical inner surface. The opening 333 is an exemplary first path, the inner surface 333a is an exemplary first inner surface, and the laser beam 200 is an exemplary energy ray.

The body 330 is provided with another opening 334. The opening 334 surrounds the opening 333 with spacing. The opening 334 extends in a direction tilted relative to the longitudinal direction of the body 330. The opening 334 penetrates through the body 330. The opening 334 may be also referred to as a second through-hole. The opening 334 opens to the end face 331 of the body 330.

The opening 334 serves as the path of the powder material 121. The powder material 121 is carried by gas in the opening 334. The powder material 121 is discharged toward the melting pool P from the opening 334 in the end face 331.

As illustrated in FIG. 4, the opening 334 has an annular cross section in the transverse direction intersecting the Z direction. As illustrated in FIG. 3, the annular section of the opening 334 has a diameter that decreases as it approaches the end face 331. The opening 334 is a constant gap “d” irrespective of the distance from the end face 331. The opening 334 is defined by two inner surfaces 334a, i.e., a convex curved surface 334a1 and a concave curved surface 334a2. The convex curved surface 334a1, which is the inner one of the two inner surfaces 334a, is a conical outer surface. The concave curved surface 334a2, which is the outer one of the two inner surfaces 334a, is a conical inner surface. The concave curved surface 334a2 faces the convex curved surface 334a1 and surrounds the convex curved surface 334a1 with the gap “d”. The opening 334 is an exemplary second path, and the inner surfaces 334a are an exemplary second inner surface.

An apex Pt of a virtual conical face Vc passing through the center of the gap between the two inner surfaces 334a of the opening 334 is located away from the end face 331 by a certain distance L in the Z direction. The apex Pt coincides with the central line C of the opening 333. Because of this, the laser beam 200 and the powder material 121 converge in the vicinity of the apex Pt of the virtual conical face Vc. In the additive manufacturing apparatus 1, the relative distances among the end face 331 and the stage 12, the object 100, and the object 110 in the Z direction are set or adjusted as appropriate to allow the laser beam 200 and the powder material 121 to converge on the melting pool P.

The body 330 also includes a first component 330a having an outer peripheral surface being the convex curved surface 334a1 of the opening 334, and a second component 330b having the concave curved surface 334a2 of the opening 334 being an inner peripheral surface and the outer peripheral surface 332 being an outer peripheral surface. The first component 330a and the second component 330b are integrated together in certain relative postures and positions to create the body 330 with the opening 334.

The inventors have found through their diligent study and research that providing a relatively rough region on the inner surfaces 334a of the opening 334 through which the powder material 121 flows can enhance the convergence of the discharged powder material 121 from the opening 334, as compared with mirrored inner surfaces 334a. The inventors have further found through their diligent study and research that part of the reason for such enhanced convergence of the material 121 is that the powder material 121 is reflected by the rough region, reducing speed components of the powder material in a direction substantially orthogonal to the flow of gas and causing the powder to flow with the gas. Thus, the rough region may be also referred to as a deceleration region, a buffer region, or a low-reflective region.

The rough region is provided, for example, on the entire convex curved surface 334a1 and concave curved surface 334a2 of the body 330. The rough region is an exemplary first region.

The rough region may be, for example, a texture surface. The texture surface is fabricated by texturing, and may be also referred to as a texturing surface. The texturing provides a texture surface with relatively fine irregularities on the surface of an object, or in this case, the inner surfaces 334a.

Examples of the irregularities include striped (waveform), meshed, and dot-patterned. The striped irregularities are such that grooves or ribs extending in one direction are arranged in another direction intersecting the one direction. The meshed irregularities are such that grooves extending in one direction and arranged in stripes in another direction intersect grooves extending in another direction and arranged in stripes in the one direction, or ribs extending in one direction and arranged in stripes in another direction intersect ribs extending in another direction and arranged in stripes in the one direction. The dot-patterned irregularities include discretely arranged dimples or small protrusions. Such irregularities are, for example, appropriately minute in size and depth (height) in the scale of millimeters to nanometers. Grooves, ribs, recesses, or protrusions of the irregularities may be arranged regularly, repetitively, or at random. The depth of the grooves, the width of the grooves, the height of the ribs, the width of the ribs, the diameter of the recesses, the depth of the recesses, the diameter of the protrusions, or the height of the protrusions is set to, for example, equal to or larger than the particle size of the powder material 121. The grooves or ribs may extend in the circumferential direction of the central line C or in a direction intersecting the generatrix of the virtual conical face Vc. For dealing with a vortex flow in the opening 334, the grooves or the ribs may extend substantially in parallel to the generatrix of the virtual conical face Vc.

The texturing may employ various kinds of methods. The texturing may be, for example, sandblasting, shot blasting, roller burnishing, cutting, polishing, or similar mechanical processing. The texturing may also be, for example, high-energy machining such as laser machining, chemical etching, ion plating, or nanoimprinting. Alternatively, the texturing may be any selective combination thereof.

The first component 330a and the second component 330b may be individually subjected to the texturing before the first component 330a and the second component 330b are integrated into the body 330, for example.

The irregularities may extend annularly about the central line C. In this case, the grooves or ribs of a minute width annularly extend on the rough region, substantially in the circumferential direction of the central line C.

The irregularities may extend in a helical form about the central line C. In this case, for example, the grooves or ribs having a minute width are in a single helix or multiple helices on the rough region.

The rough region may be, for example, a diffusely reflective surface that randomly reflects the powder material 121. The diffusely reflective surface refers to an irregular surface that randomly reflects the powder material 121. The diffusely reflective surface can be formed by, for example, texturing described above. The diffusely reflective surface may be also referred to as a dispersedly reflective surface.

For example, the rough region may have a surface roughness higher than another surface of the body 330. As an example, the surface roughness of the rough region may be set to higher than the surface roughness of the inner surface 333a of the opening 333. At a higher surface roughness of the inner surface 333a, the powder material 121 may attach to the inner surface 333a, forming refuse or hindering the emission of the laser beam 200. At a higher surface roughness of the inner surface 333a, the laser beam 200 may be diffusely reflected by the inner surface 333a, decreasing the convergence of the laser beam 200. The surface roughness may be, for example, represented by a central-line average roughness Ra, a ten-point average height Rz, or a maximum height Rmax.

As another example, the surface roughness of the rough region may be set to higher than the surface roughness of the outer peripheral surface 332 of the leading end 330t of the body 330. At a higher surface roughness of the outer peripheral surface 332, the powder material 121 may attach to the outer peripheral surface 332, forming refuse.

The rough region may have a higher friction coefficient for the powder material 121 than another surface of the body 330, for example. As an example, the friction coefficient of the rough region may be set to higher than the friction coefficient of the inner surface 333a of the opening 333. With a higher friction coefficient of the inner surface 333a, the powder material 121 may attach to the inner surface 333a, forming refuse or hindering the emission of the laser beam 200. With a higher friction coefficient of the inner surface 333a, the laser beam 200 may be diffusely reflected by the inner surface 333a, lowering the convergence of the laser beam 200.

As another example, the friction coefficient of the rough region for the powder material 121 may be set to higher than the friction coefficient of the outer peripheral surface 332 of the leading end 330t of the body 330. With a higher friction coefficient of the outer peripheral surface 332, the powder material 121 may attach to the outer peripheral surface 332, forming refuse.

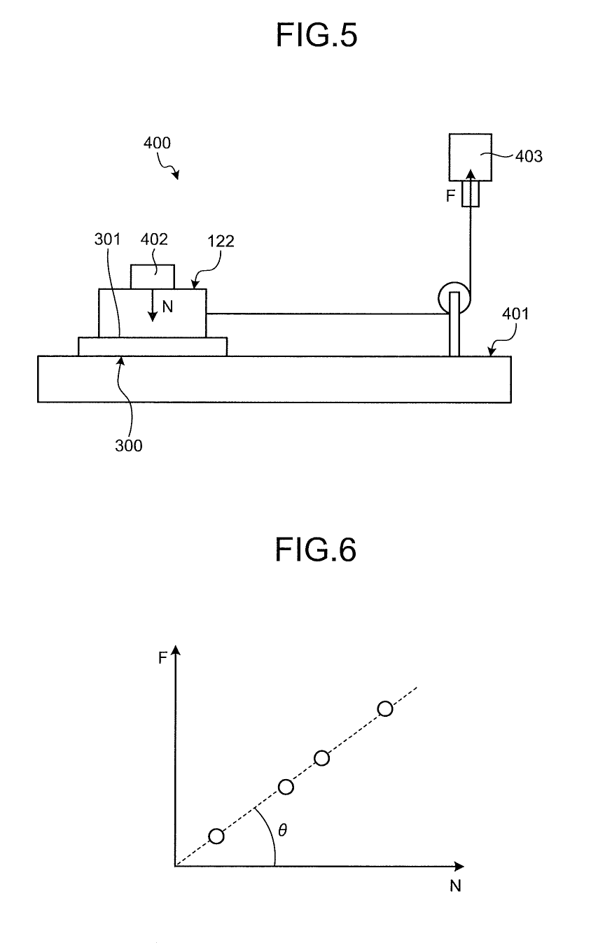

FIG. 5 is a diagram illustrating a measurement device 400. The measurement device 400 can measure the friction coefficient of each surface of the body 330 for the powder material 121. A sample 300, having a surface to measure 301 with the same property as each body surface, is fixed onto a stage 401 as a subject of measurement of the friction coefficient. A mass 122 of the powder material 121 is placed on the surface 301 of the sample 300. The powder particles are densely exposed from at least part of the mass 122 in contact with the surface 301. A weight 402 is placed on the mass 122 to apply a vertical load N to the surface 301, and at the same time a tensile-force meter 403 pulls the mass 122 to measure a tensile force F. The tensile-force meter 403 measures the tensile force F while individually placing weights 402 of different weights (vertical loads N) on the mass 122.

FIG. 6 is a graph illustrating the correlation between the vertical loads N and the tensile force F measured by the measurement device 400. As illustrated in FIG. 6, the measurement device 400 measures the tensile force F for each sample 300 using the different vertical loads N to experimentally find the correlation between each vertical load N and the tensile force F. In FIG. 6, the friction coefficient μ of the surface 301 is expressed by the gradient (tan θ) of a first-order approximate function indicating the correlation between each vertical load N and the tensile force F. The approximate function is found by a regression analysis such as a least-square method.

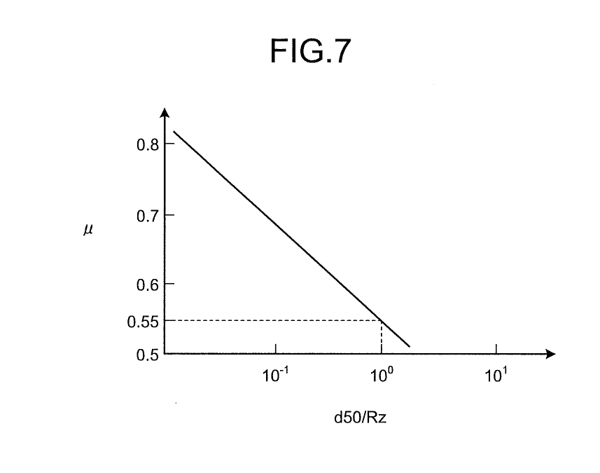

FIG. 7 is a graph illustrating the correlation between the particle size (diameter) of the powder material 121 and the friction coefficient. Reference sign “d50” represents an exemplary representative value of the particle size, i.e., the median value of distribution of the particle sizes of the powder material 121. Reference sign “Rz” represents the height (depth) of the irregularities of the surface roughness. The ratio “d50/Rz” represents a particle size non-dimensionalized by the surface roughness. The smaller the value“d50/Rz” is, the smaller the particle size relative to the surface roughness is, and the larger “d50/Rz” is, the larger the particle size relative to the surface roughness is. The correlation illustrated in FIG. 7 was obtained through experiment. The inventors have found through their diligent study and research that if the rough region has the surface roughness equivalent to or larger than the particle size of the powder material 121, that is, d50/Rz≤1, the convergence effect of the rough region can be improved. As is seen from the graph illustrated in FIG. 7, d50/Rz≤1 holds when μ≥0.55, thus, having the friction coefficient μ being equal to or larger than 0.55 is the condition for the rough region to enhance convergence.

As described above, in the present embodiment, for example, at least part of the inner surfaces 334a (second inner surface) of the opening 334 (second path) includes the rough region (first region) having a larger friction coefficient for the powder material 121 than the friction coefficient of at least one of the inner surface 333a (first inner surface) of the opening 333 (first path) and the outer peripheral surface 332. With this configuration, for example, it is possible to increase the convergence of the powder material 121 when discharged through the opening 334, and hinder the powder material 121 from attaching to the inner surface 333a and the outer peripheral surface 332. In addition, for example, it is possible to reduce scattering of the laser beam by the inner surface 333a.

In the present embodiment, for example, the surface roughness of the rough region is larger than that of at least one of the inner surface 333a and the outer peripheral surface 332. With this configuration, for example, it is possible to increase the convergence of the powder material 121 when discharged through the opening 334, and hinder the powder material 121 from attaching to the inner surface 333a and the outer peripheral surface 332. In addition, for example, it is possible to reduce scattering of the laser beam by the inner surface 333a.

In the present embodiment, for example, the opening 334 is an annular path, and the inner surfaces 334a of the opening 334 include the convex curved surface 334a1 and the concave curved surface 334a2. With this configuration, for example, the body 330 provided with the annular opening 334 can attain the above-described effect due to the rough region.

In the present embodiment, for example, the body 330 of the nozzle 33 includes the first component 330a having the inner surface 333a of the opening 333 and the convex curved surface 334a1 of the opening 334, and the second component 330b surrounding the first component 330a and having the concave curved surface 334a2 and the outer peripheral surface 332. With this configuration, for example, the first component 330a or the second component 330b is solely subjected to the roughening. This enables reduction in processing work and cost as compared with the assembly of the first component 330a and the second component 330b subjected to the roughening.

In the present embodiment, for example, the inner surfaces 334a of the opening 334 are at least partially provided with the texture surface. With this configuration, for example, it is possible to increase the convergence of the powder material 121 when discharged through the opening 334.

The embodiment of the present invention is exemplified as above, but the embodiment is merely exemplary and not intended to limit the scope of the present invention. The embodiment can be implemented in various other forms, and various omissions, substitutions, combinations, and modifications can be made without departing from the scope of the present invention. The embodiment and its modifications are included in the scope and gist of the invention, and are also included in the invention described in the claims and in equivalents thereof. Furthermore, the present invention can be implemented by configurations and controls (technical features) other than those disclosed in the embodiment. The present invention can attain at least one of various results (including effects and their derivative effects) attained by the technical features.

For example, in the embodiment, the rough region is provided on the entire inner surfaces 334a (the convex curved surface 334a1 and the concave curved surface 334a2) of the opening 334, but the present invention is not limited thereto. The rough region may be provided on, for example, only one of the convex curved surface 334a1 and the concave curved surface 334a2. The rough region may be partially provided on at least one of the convex curved surface 334a1 and the concave curved surface 334a2. The rough region may be provided between the exit of the opening 334 in the end face 331 and the entrance thereof opposite to the end face 331. The rough region on the convex curved surface 334a1 and the rough region on the concave curved surface 334a2 may face each other. The part, of the opening 334, facing the rough region is annular and continuous at least in the circumferential direction of the central line C. In this case, this part faces at least one of the rough regions on the convex curved surface 334a1 and on the concave curved surface 334a2. Specifically, the annular rough region may be provided on at least one of the convex curved surface 334a1 and the concave curved surface 334a2, or the rough regions may be alternately provided on the convex curved surface 334a1 and on the concave curved surface 334a2 in the circumferential direction. The convex curved surface 334a1 is not limited to a conical outer surface, and the concave curved surface 334a2 is not limited to a conical inner surface.

The specifications of grooves, ribs, recesses, and protrusions of the irregularities may be changed as appropriate.

What is claimed:

1. A nozzle of an additive manufacturing device, the nozzle comprising:
a first inner surface that defines a first path through which an energy ray passes; and
a second inner surface that defines a second path that extends along the first path and through which gas and a powder material pass, wherein
the first path opens to a leading end of the nozzle, and the second path opens to near or around the first path, and
at least part of the second inner surface includes a first region having a larger friction coefficient for the powder material than a friction coefficient of at least one of the first inner surface and an outer peripheral surface of the leading end.

2. The nozzle according to claim 1, wherein
the first region has a surface roughness larger than a surface roughness of at least one of the first inner surface and the outer peripheral surface.

3. The nozzle according to claim 1, wherein
the second path is an annular path surrounding the first path, and
the second inner surface includes a convex curved surface and a concave curved surface surrounding the convex curved surface with a gap.

4. The nozzle according to claim 3, further comprising:
a first component including the first inner surface and the convex curved surface; and
a second component surrounding the first component and including the concave curved surface and the outer peripheral surface.

5. A nozzle of an additive manufacturing device, the nozzle comprising:
a first inner surface that defines a first path through which an energy ray passes;
a second inner surface that defines a second path that extends along the first path and through which gas and a powder material pass; and
a texture surface provided on at least part of the second inner surface.

6. An additive manufacturing device comprising:
the nozzle according to claim 1;
a light source configured to generate the energy ray; and
a supplier configured to supply the powder material to the nozzle.

7. An additive manufacturing device comprising:
the nozzle according to claim 5;
a light source configured to generate the energy ray; and
a supplier configured to supply the powder material to the nozzle.
